(19) United States
(12) Patent Application Publication
(10) Pub. No.: US 2009/0188389 A1
(43) Pub. Date: Jul. 30, 2009

(54) Particulate filter for an exhaust aftertreatment system of a machine and filtering method thereof

(75) Inventors: Herbert F.M. Dacosta, Peoria, IL (US); Thomas E. Paulson, Groveland, IL (US); Michael J. Pollard, Peoria, IL (US)

Correspondence Address: CATERPILLAR c/o LIELL, MCNEIL & HARPER;Intellectual Property Department, AH9510, 100 N.E. Adams, Peoria, IL, 61629-9510, US

(73) Assignee: Caterpillar Inc.

(21) Appl. No.: 12/011,860

(22) Filed: Jan. 30, 2008

(51) Int. Cl. B01D 46/00; B01D 39/10

(52) U.S. Cl. 95/285; 95/273; 55/525

(57) ABSTRACT

A particulate filter includes a filter element comprising a non-perforated tube having an exhaust inlet at a first end and an exhaust outlet at a second end. A fibrous metallic filter medium is disposed within the filter element and is configured to trap particulate matter from an exhaust gas. A first metallic foam disk is attached at the second end of the filter element, and retains the fibrous metallic filter medium within the filter element. A second metallic foam disk may be attached at the first end of the filter element and may allow the particulate filter to be reversed with respect to an exhaust gas flow.

### TECHNICAL FIELD

The present disclosure relates generally to a particulate filter for an exhaust aftertreatment system of a machine, and more particularly to a particulate filter including at least one non-perforated tubular filter element having a fibrous metallic filter medium disposed therein.

### BACKGROUND

Operation of internal combustion engines typically results in the generation of particulate matter including inorganic species (ash), sulfates, small organic species generally referred to as soluble organic fraction (SOF), and hydrocarbon particulates or “soot.” Various strategies have been used for preventing the release of such particulate matter into the environment, including the use of particulate filters, available in a variety of designs. Particulate filters are used in both on-highway and off-highway applications, and typically include a porous ceramic material positioned in the path of exhaust gas exiting the engine. The particulate filter traps the particulate matter from the exhaust gas, thus preventing its release into the environment.

Periodically, or once a substantial amount of particulate matter is collected within the particulate filter, it must be cleaned out, or regenerated, to prevent blockage. While a variety of strategies of both active and passive regeneration are known, a common regeneration method includes quickly heating the particulate matter to a temperature at which the trapped particles oxidize or combust. This involves heating the exhaust gas and, as a result, the particulate filter to very high temperatures. These wide temperature swings experienced by particulate filters, particularly during regeneration, may result not only in physical damage but also in chemical degradation of the filter material over time.

Another factor to be considered, relevant to particulate filter design, includes the use of particulate filters in off-highway applications. Specifically, many off-highway machines operate over relatively rugged terrain where physical shocks may be experienced. In the case of ceramic particulate filters, in particular, it should be appreciated that such impact shocks may cause the filter material to crack, thus reducing the performance of the particulate filter. Although more recently developed filter materials, such as fibers, wool, and yarns, both metallic and ceramic, may be less susceptible to impact induced damage, they may still suffer from various other shortcomings, such as chemical degradation caused by extreme regeneration temperatures.

Another factor to consider that may be relevant to all on-highway and off-highway applications, regardless of the filter material, relates to the limited amount of space available for mounting particulate filters on or within machines or vehicles. While certain older designs may have had ample space available for mounting particulate filters, in certain newer designs space may be at more of a premium. It will thus be readily apparent that engineers are faced with a variety of challenges in designing suitable particulate filters, namely, fitting particulate filters of suitable size, shape, durability, and material within increasingly restricted spatial envelopes.

The present disclosure is directed to one or more of the problems set forth above.

### SUMMARY OF THE DISCLOSURE

In one aspect, a particulate filter includes a filter element comprising a non-perforated tube having an exhaust inlet at a first end and an exhaust outlet at a second end. A fibrous metallic filter medium is disposed within the filter element. At least one metallic foam disk is attached at the second end of the filter element.

In another aspect, a machine includes an exhaust aftertreatment system having a predefined spatial envelope for a particulate filter assembly. A housing of the particulate filter assembly is shaped to fit within the predefined spatial envelope. A plurality of filter elements are arranged in a bundle and disposed within the housing. The bundle includes a number and an arrangement of filter elements selected to fit within the housing. Each of the filter elements includes a non-perforated tube having an exhaust inlet at a first end and an exhaust outlet at a second end, and includes a fibrous metallic filter medium disposed therein.

In yet another aspect, a method of filtering an exhaust gas includes a step of directing the exhaust gas through each of a plurality of tubular filter elements of a particulate filter. Particulate matter from the exhaust gas is trapped using a fibrous metallic filter medium disposed within each of the filter elements. The exhaust gas is also passed through at least one metallic foam element positioned at a second end of the particulate filter.

### BRIEF DESCRIPTION OF THE DRAWINGS

FIG. 1 is a perspective view of a machine according to the present disclosure;

FIG. 2 is a perspective view of a partially disassembled particulate filter assembly according to one embodiment;

FIG. 3 is a perspective view of a partially disassembled particulate filter assembly according to another embodiment;

FIG. 4 is a sectioned side view of a filter element for a particulate filter assembly according to one embodiment;

FIG. 5 is an end view of a bundle of filter elements shown supported in a support plate according to one embodiment;

FIG. 6 is an end view of a bundle of filter elements shown supported in a support plate according to another embodiment; and

FIG. 7 is an end view of a bundle of filter elements shown supported in a support plate according to yet another embodiment.

### DETAILED DESCRIPTION

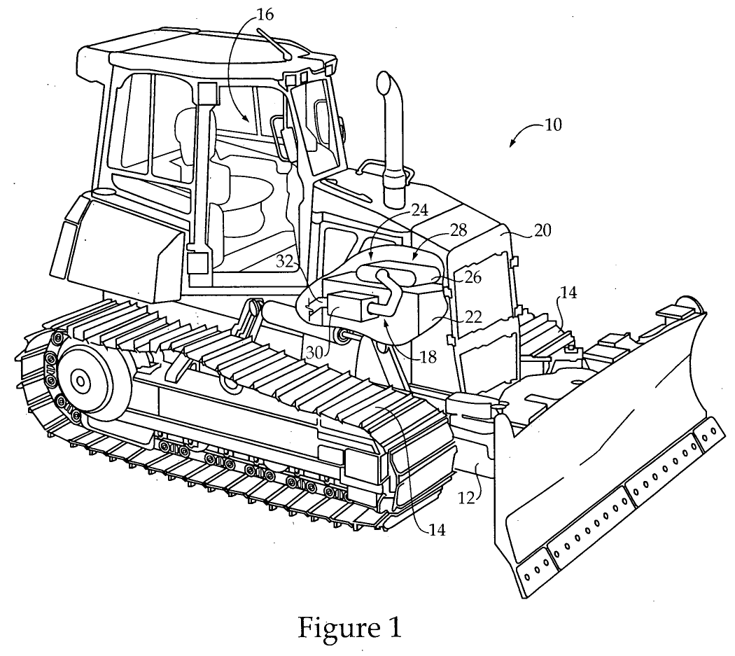

An exemplary embodiment of a machine 10 is shown generally in FIG. 1. The machine 10 may be an on-highway or off-highway vehicle, such as, for example, a track-type tractor, or may be stationary, such as a generator set. The machine 10 may include a frame 12, ground engaging tracks 14 mounted to the frame 12, and an operator control station 16 also mounted to the frame 12. Machine 10 may further include an engine system 18 positioned at a front portion of the machine 10, such as under a hood 20.

The engine system 18 may include an internal combustion engine 22, such as a compression ignition engine, and an exhaust aftertreatment system 24 including a particulate filter assembly 26. The particulate filter assembly 26 includes a design and configuration adapted to fit the particulate filter assembly 26 within a predefined spatial envelope 28. The predefined spatial envelope 28 may be positioned within the engine system 18, as shown, or elsewhere on the machine 10, and may include a space that is dictated by a variety of factors, including the size and shape of various components of the engine system 18. Such components may include, by way of example only, a turbocharger 30 coupled with an exhaust passage 32 of the engine system 18, the hood 20, and the frame 12. It should be appreciated that various other components may dictate the location, size, and shape of the predefined spatial envelope 28, depending on the design of the machine 10.

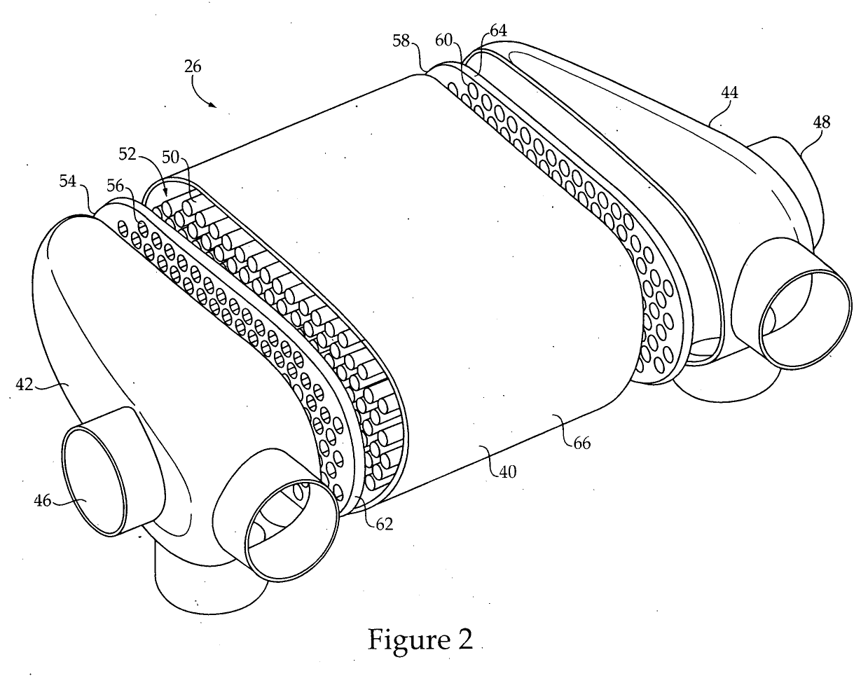

Turning now to FIG. 2, one embodiment of the particulate filter assembly 26 is shown partially disassembled. The particulate filter assembly 26 includes a housing 40, such as a symmetrical housing, having an inlet portion 42 and an outlet portion 44. The inlet portion 42 includes an exhaust inlet 46 for receiving exhaust gas from the internal combustion engine 22. The exhaust gas then passes through the housing 40 and is directed out of the particulate filter assembly 26 through an exhaust outlet 48 of the outlet portion 44. It should be appreciated that additional fluid connections to the particulate filter assembly 26 may exist for various purposes, such as exhaust gas recirculation, exhaust gas cooling, and connecting with one or more turbochargers. The housing 40, including one or both of the inlet portion 42 and the outlet portion 44, may be shaped to fit within the predefined spatial envelope 28. According to one embodiment, the particulate filter assembly 26 or, more specifically, the housing 40 may include a non-circular cross section, such as a generally oblong cross section, as depicted in FIG. 2. It should be appreciated, however, that a variety of cross sections corresponding to different predefined spatial envelopes are contemplated.

The particulate filter assembly 26 also includes at least one filter element 50. Although an embodiment including only one filter element 50 disposed within the housing 40 is contemplated, an embodiment including a plurality of filter elements 50 is described. The plurality of filter elements 50 may include identical filter elements 50 arranged in a bundle 52 and disposed within the housing 40. The bundle 52 may include a number, such as, for example, twenty or more, and an arrangement of filter elements 50 selected to fit within the housing 40. Each of the filter elements 50, described in greater detail below, may be configured to filter exhaust gas passing from the exhaust gas inlet 46 to the exhaust gas outlet 48.

The particulate filter assembly 26 may also include a first support plate 54 having a plurality of holes 56 configured to support first ends of each of the filter elements 50. The particulate filter assembly 26 may also include a second support plate 58 having holes 60 for supporting second ends of the filter elements 50. The holes 56 and 60 may be arranged in a pattern corresponding to an arrangement and distribution of filter elements 50 in bundle 52. Each of the support plates 54 and 58 may include an outer perimeter or edge 62 and 64, respectively, which is matched to a shape of the housing 40 or, more specifically, an intermediate portion 66 of the housing 40. For example, support plates 54 and 58 may have oblong shapes similar to that shown in FIG. 2, or they might have a wide variety of other shapes such as triangular, circular, square, trapezoidal or even irregular and non-polygonal shapes. The bundle 52, as should be appreciated, may have an essentially limitless variety of configurations. This versatility allows bundles of the same basic component 50 to be grouped in different numbers and shapes to suit different demands for a variety of machines in a given manufacturer's product line.

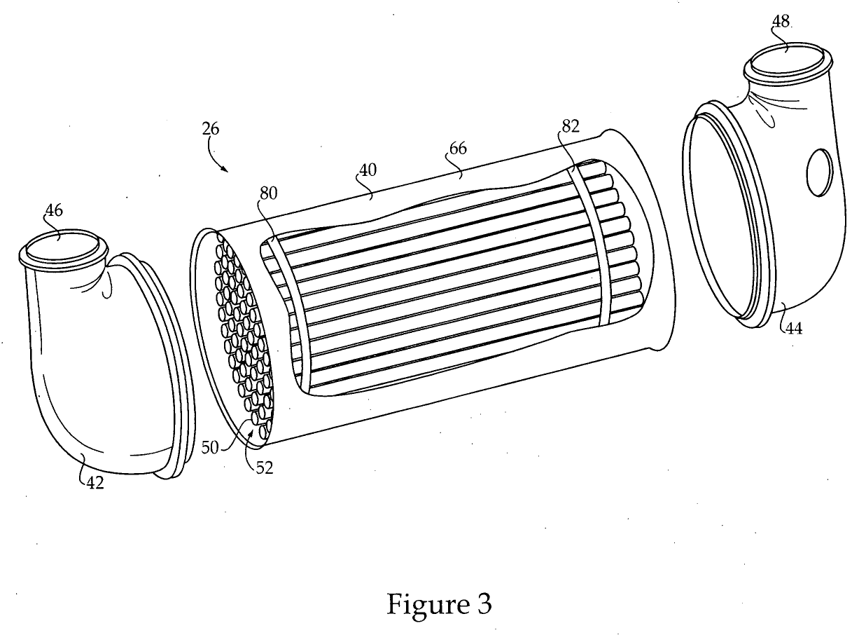

An alternative embodiment of particulate filter assembly 26, shown in partial cutaway, is depicted in FIG. 3. The particulate filter assembly 26 of FIG. 3 is similar in design to the particulate filter assembly 26 of FIG. 2, but includes a generally cylindrical shape. Specifically, particulate filter assembly 26 may be used where the predetermined spatial envelope 28 includes a matching cylindrical shape or where space and shape restrictions are relatively minimal, such as where the particulate filter assembly 26 is made cylindrical for manufacturing or handling convenience. The particulate filter assembly 26, similar to the embodiment of FIG. 2, may include inlet portion 42, outlet portion 44, and intermediate portion 66, all of which may generally be referred to as housing 40.

The particulate filter assembly 26 may also include the bundle 52 of filter elements 50; however, the support plates 54 and 58 depicted in FIG. 2 are removed from the embodiment of FIG. 3. Instead, the bundle 52 includes a tightly packed arrangement of filter elements 50 held together by one or more well known clamps, such as clamps 80 and 82. For example, annular clamps 80 and 82 may be positioned about the bundle 52 and then reduced in diameter to effect a relatively tight clamping force around filter elements 50. According to one embodiment, the filter elements 50 of bundle 52 may be positioned at an average distance from one another that is less than an average diameter of the filter elements 50 comprising bundle 52. According to another embodiment, each of the filter elements 50 may contact adjacent filter elements 50 of the bundle 52.

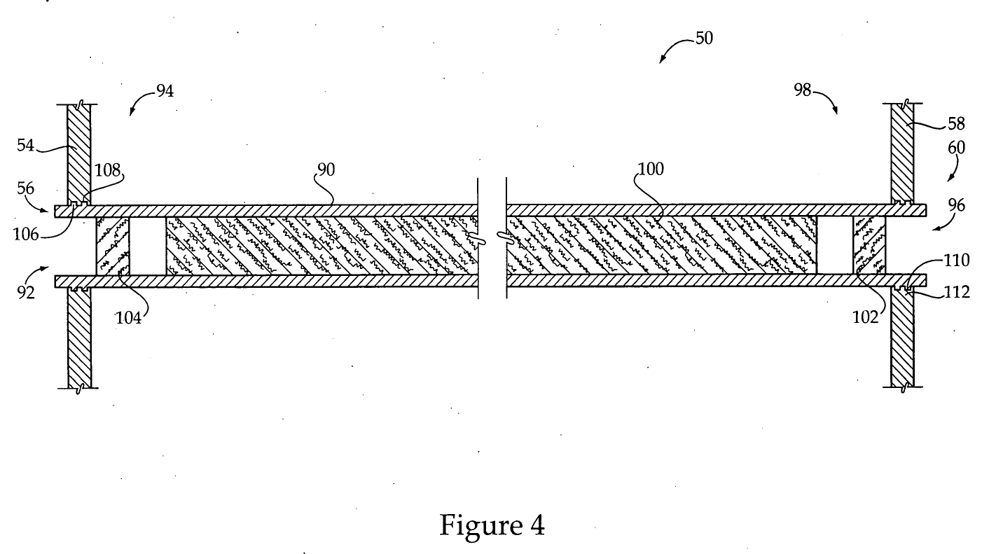

Each of the filter elements 50 may include a non-perforated tube 90, as shown in FIG. 4. The non-perforated tube 90 may, for example, comprise a stainless steel material and includes an exhaust inlet 92 at a first end 94 and an exhaust outlet 96 at a second end 98. A fibrous metallic filter medium 100, such as a filter medium including non-sintered metal fibers, is disposed or packed within the non-perforated tube 90 for trapping particulate matter from the exhaust gas. Preferably, the non-sintered or, alternatively, sintered metal fibers may be based on iron, chromium, and aluminum alloys. However, any high temperature metals are contemplated for use as the filter medium.

A first metallic foam element 102 is attached at the second end 98 of the filter element 50. The first metallic foam element 102 may, for example, include a metallic foam retainer or disk disposed within the non-perforated tube 90 for retaining the fibrous metallic filter medium 100 within the non-perforated tube 90. Although the first metallic foam element 102 is shown disposed within the non-perforated tube 90, it should be appreciated that the metallic foam element 102 may be otherwise attached, such as by brazing, at the second end 98 thereof. For embodiments utilizing a plurality of filter elements 50, a metallic foam elements 102 may be disposed within each of the filter elements 50 or, alternatively, one metallic foam element 102 may be positioned at a second end of the bundle 52. A second metallic foam element 104 may be attached at the first end 94 of the filter element 50. The second metallic foam element 104 may also include a metallic foam retainer or disk disposed within the non-perforated tube 90. The first and second metallic foam elements 102 and 104 may, for example, include a nickel based alloy or other highly porous foam.

Filter element 50 is shown in FIG. 4 having its first end 94 supported in one of the holes 56 of support plate 54 and its second end 98 supported in holes 60 of support plate 58. In particular, the non-perforated tube 90 may include one or more radial projections 106 received in one or more grooves 108 of support plate 54. Such a process of joining the non-perforated tube 90 and support plate 58 may, for example, include swagging, adhering, welding, or bolting. However, other methods of providing a strong, mechanical joint are also contemplated. It should be appreciated that the second end 98 of filter element 50 may also be supported in a similar fashion. Specifically, the non-perforated tube 90, at the second end 98 thereof, may include one or more radial projections 110 received in one or more grooves 112 of support plate 58.

Regeneration of the particulate filter assembly 26, according to one embodiment, may employ a heating device configured to heat filter elements 50 and, in particular, the fibrous metallic filter medium 100, to a temperature sufficient to initiate and maintain combustion of accumulated soot. In one contemplated embodiment, an auxiliary regeneration device will be positioned upstream of particulate filter assembly 26 to inject and ignite fuel in the engine exhaust stream which is burned to increase the temperature of exhaust gases passing through the particulate filter assembly 26. Alternative strategies could include passive regeneration from engine heat or possibly electric heater(s) disposed between tubes 50.

Any of the fibrous metallic filter medium 100, the first metallic foam element 102, and the second metallic foam element 104 may include an oxidation catalyst coating or other catalyst coating capable of promoting particulate filtration and/or regeneration. According to one embodiment, any of the fibrous metallic filter medium 100, the first metallic foam element 102, and the second metallic foam element 104 may include a well known NO_{X} catalyst. According to another embodiment, the second metallic foam element 104 may include an oxidation catalyst coating for converting NO from the exhaust gas into NO₂. The presence of NO₂ within the upstream exhaust gas may decrease a regeneration temperature of the particulate filter assembly 26. Specifically, the presence of NO₂ in the exhaust stream may improve the efficiency of a downstream catalyst coating of the first metallic foam element 102 that assists in the decomposition of NO and NO₂ into N₂.

According to an embodiment utilizing both of the first metallic foam element 102 and the second metallic foam element 104, it should be appreciated that an orientation of the filter elements 50 may be reversed with respect to an exhaust gas entry. Specifically, a position of the bundle 52 of filter elements 50 may be reversed so that the second ends 98 of the filter elements 50 are positioned adjacent the inlet portion 42 of housing 40 and the first ends 94 are positioned adjacent the outlet portion 44. This symmetrical configuration and reversible nature of the particulate filter assembly 26 may allow for extended usage of the particulate filter assembly 26 before an ash removal process is necessary, or after repeated ash cleanings have resulted in degraded performance in one direction.

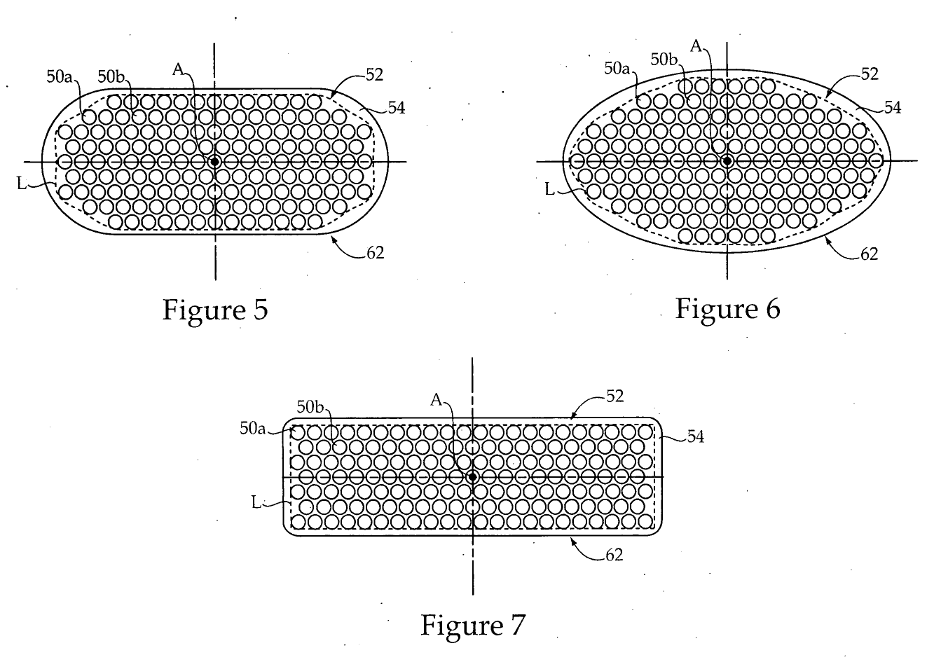

Turning now to FIG. 5, there is shown an end view of one embodiment of bundle 52 supported in support plate 54. The bundle 52 may include peripherally located filter elements 50a and internally located filter elements 50b, having a packing arrangement. The packing arrangement may include a number and arrangement of filter elements 50 selected to fit within the housing 40, where the housing 40 is shaped to fit within the predetermined spatial envelope 28 of the machine 10. The peripherally located filter elements 50a may define a perimetric line L that is at least partially matched to a shape of support plate 54. As described above, the support plate 54 includes a peripheral edge 62 that is at least partially matched to the shape of the housing 40.

The bundle 52 includes a longitudinal axis A, and may be symmetrical with respect to an axis perpendicular to the axis A. According to the embodiment of FIG. 5, the bundle 52 may include an oblong cross section that is perpendicular to the longitudinal axis A. Turning now to FIG. 6, the bundle 52, and support plate 54 include a substantially oval cross section perpendicular to the longitudinal axis A, whereas a rectangular cross section is shown in FIG. 7. According to each of the illustrated embodiments, it should be appreciated that the bundle 52, support plates 54 and 58, and housing 40 may all have similar cross sections based on their intended application.

### INDUSTRIAL APPLICABILITY

The particulate filter of the present disclosure may find application in a variety of on-highway, off-highway, or even stationary machines having exhaust aftertreatment systems. Although a track-type tractor is depicted, it should be appreciated that the particulate filter, as described herein, may be used with wheel loaders, articulated trucks, or other types of construction, mining, and agricultural machines. Further, the particulate filter, as described, may be specifically applicable to exhaust aftertreatment systems having predefined spatial envelopes that are subject to space and shape constraints.

Referring to FIGS. 1-7, an exemplary embodiment of an off-highway machine 10, such as a track-type tractor, includes an engine system 18. The engine system 18 may include an internal combustion engine 22, such as a compression ignition engine, and an exhaust aftertreatment system 24 including a particulate filter assembly 26. The particulate filter assembly 26 includes a design and configuration adapted to fit the particulate filter assembly 26 within a predefined spatial envelope 28. The predefined spatial envelope 28 may include a space that is dictated by a variety of factors, including the size and shape of various components of the engine system 18.

The particulate filter assembly 26 includes a housing 40 that is shaped to fit within the predefined spatial envelope 28 and that includes at least one filter element 50 disposed therein. According to one embodiment, the particulate filter assembly 26 includes a plurality of filter elements 50 arranged in a bundle 52 and disposed within the housing 40. The bundle 52 may include a number, such as, for example, twenty or more, and an arrangement of filter elements 50 selected to fit within the housing 40.

Each of the filter elements 50 includes a non-perforated tube 90 having an exhaust inlet 92 at a first end 94 and an exhaust outlet 96 at a second end 98, and a fibrous metallic filter medium 100 disposed therein. Non-sintered metal fibers may be less costly than sintered metal fibers and, therefore, may be preferable as the fibrous metallic filter medium 100. A first metallic foam element 102 may be attached at the second end 98 of the filter element 50. According to one embodiment, a second metallic foam element 104 is also attached at the first end 94 of the filter element 50. This substantially symmetrical design may allow the filter elements 50 to be reversed with respect to an exhaust gas flow.

First and second support plates 54 and 58 may be used to support first and second ends of the filter elements 50, as shown in the embodiment of FIG. 2. According to that embodiment, each of the support plates 54 and 58 may include an outer perimeter or edge 62 and 64, respectively, which is matched to a shape of the housing 40. According to an alternative embodiment, depicted in FIG. 3, the filter elements 50 may be tightly packed and held together using one or more clamps, such as annular clamps 80 and 82. Specifically, clamps 80 and 82 may be positioned about the bundle 52 and then reduced in diameter to effect a relatively tight clamping force around filter elements 50.

Exhaust gas, according to the present disclosure, may be filtered by directing the exhaust gas through each of the plurality of tubular filter elements 50 of the particulate filter assembly 26. Particulate matter from the exhaust gas is trapped using the fibrous metallic filter medium 100 disposed within each of the filter elements 50. The exhaust gas is then passed through at least one metallic foam element, such as first metallic foam element 102. The first metallic foam element 102 is positioned downstream of the fibrous metallic filter medium 100 and may retain the filter medium 100 within each of the filter elements 50. It should be appreciated that the first metallic foam element 102 may also trap particulate matter from the exhaust gas.

The filter elements 50 may also include a second metallic foam element 104 positioned at first ends 94 of the filter elements 50. The second metallic foam element 104 may be similar to the first metallic foam element 102 in both form and function. It should be appreciated that if the orientation of the filter elements 50 is reversed with respect to an exhaust gas flow, the second metallic foam element 104 may then be positioned downstream of the fibrous metallic filter medium 100 and may retain the filter medium 100 within each of the filter elements 50. It should also be appreciated that one or more of the fibrous metallic filter medium 100, first metallic foam element 102, and second metallic foam element 104 may include a catalyst coating, such as, for example, an oxidation catalyst, for promoting particulate filtering and/or regeneration.

The particulate filter assembly 26, as described herein, includes a bundle of filter elements 50 that may be at least partially matched to a shape of the housing 40, which is shaped to fit within the predefined spatial envelope 28. Therefore, rather than being restricted solely to cylindrical shapes or other universal designs, the present disclosure provides for vastly greater flexibility in filter shape design. Specifically, the number and arrangement of filter elements 50 within the bundle 52 may be varied to fit the particulate filter assembly 26 within spatially restrictive or spatially complex envelopes within the machine 10. Additionally, the generally symmetrical nature of the filter elements 50 of bundle 52 may allow the particulate filter to be reversed, thus extending an effective usage period of the particulate filter assembly 26.

It should be understood that the above description is intended for illustrative purposes only, and is not intended to limit the scope of the present disclosure in any way. Thus, those skilled in the art will appreciate that other aspects of the disclosure can be obtained from a study of the drawings, the disclosure and the appended claims.

What is claimed is:

1. A particulate filter, comprising:
a filter element including a non-perforated tube having an exhaust inlet at a first end and an exhaust outlet at a second end, and a fibrous metallic filter medium disposed therein; and
at least one metallic foam retainer attached at the second end of the filter element.

2. The particulate filter of claim 1, wherein the fibrous metallic filter medium includes non-sintered metal fibers.

3. The particulate filter of claim 2, wherein at least one of the metallic foam retainer and the fibrous metallic filter medium includes a catalyst coating.

4. The particulate filter of claim 3, wherein the metallic foam retainer includes a metallic foam disk disposed within the filter element.

5. The particulate filter of claim 4, further including a second metallic foam disk disposed within the filter element at the first end thereof.

6. The particulate filter of claim 2, further including a plurality of identical filter elements arranged in a bundle and disposed within a symmetrical housing, wherein the bundle includes a number and arrangement of filter elements selected to fit within the symmetrical housing.

7. The particulate filter of claim 6, further including a first support plate having holes therein configured to support first ends of each of the filter elements, and a second support plate having holes therein configured to support second ends of each of the filter elements.

8. The particulate filter of claim 7, wherein an internal surface of each of the holes of the first support plate includes a groove therein, and wherein each of the first ends of the filter elements includes a radial projection for engaging one of the grooves.

9. The particulate filter of claim 8, wherein the bundle includes a longitudinal axis and is symmetrical with respect to an axis perpendicular to the longitudinal axis.

10. A machine, comprising:
an exhaust aftertreatment system of the machine having a predefined spatial envelope for a particulate filter assembly;
a housing of the particulate filter assembly shaped to fit within the predefined spatial envelope;
a plurality of filter elements arranged in a bundle and disposed within the housing, wherein the bundle includes a number and an arrangement of filter elements selected to fit within the housing; and
wherein each of the filter elements includes a non-perforated tube having an exhaust inlet at a first end and an exhaust outlet at a second end, and a fibrous metallic filter medium disposed therein.

11. The machine of claim 10, further including at least one metallic foam disk positioned at a second end of the housing.

12. The machine of claim 11, wherein each of the filter elements includes a metallic foam disk disposed therein and positioned at the second end of the filter element.

13. The machine of claim 10, further including a first support plate having holes therein configured to support the first ends of each of the filter elements, and a second support plate having holes therein configured to support the second ends of each of the filter elements, and wherein each of the first and second support plates has a perimeter matched to the shape of the housing.

14. The machine of claim 13, wherein the housing includes a longitudinal axis and further includes an oblong cross section perpendicular to the longitudinal axis.

15. The machine of claim 13, wherein the housing includes a longitudinal axis and further includes a rectangular cross section perpendicular to the longitudinal axis.

16. A method of filtering an exhaust gas, comprising:
directing the exhaust gas through each of a plurality of tubular filter elements of a particulate filter;
trapping particulate matter from the exhaust gas using a fibrous metallic filter medium disposed within each of the filter elements; and
passing the exhaust gas through at least one metallic foam element positioned at a second end of the particulate filter.

17. The method of claim 16, wherein the passing step includes retaining the fibrous metallic filter medium within each of the filter elements using the at least one metallic foam element.

18. The method of claim 16, further including converting NO from the exhaust gas into NO₂ using an oxidation catalyst coating of at least one of a second metallic foam element positioned at a first end of the particulate filter and the fibrous metallic filter medium.

19. The method of claim 18, further including converting NO_{X} from the exhaust gas into N₂ using a catalyst coating of at least one of the fibrous metallic filter medium and the metallic foam element positioned at the second end of the particulate filter.

20. The method of claim 18, further including reversing an orientation of the tubular filter elements with respect to an exhaust gas entry.
